(19) United States
(12) Patent Application Publication
(10) Pub. No.: US 2023/0026382 A1
(43) Pub. Date: Jan. 26, 2023

(54) Ballast Water Treatment Agent, and Ballast Water Treatment System and Ballast Water Treatment Method Each Using Same

(71) Applicant: KURARAY CO., LTD., Okayama (JP)

(72) Inventor: Yasuhiro Tajima, Kurashiki-shi, Okayama (JP)

(73) Assignee: KURARAY CO., LTD., Okayama (JP)

(21) Appl. No.: 17/787,271

(22) PCT Filed: Dec. 16, 2020
(86) PCT No.: PCT/JP2020/046932

§ 371 Date: Jun. 17, 2022

(30) Foreign Application Priority Data
Dec. 27, 2019 (JP) 2019-238176
Dec. 27, 2019 (JP) 2019-238177

(51) Int. Cl. C02F 1/50

(52) U.S. Cl. CPC C02F 1/50; C02F 2103/008

(57) ABSTRACT

The present invention relates to a ballast water treatment pack comprising: a chlorine-based sterilizing agent; and a wrapper formed of a water-soluble film or a water-soluble fiber entangled body for wrapping the chlorine-based sterilizing agent.

### TECHNICAL FIELD

The present invention relates to a ballast water treatment pack, and a ballast water treatment system and a ballast water treatment method each using the same.

### BACKGROUND ART

It has been conventionally known to fill a ballast tank arranged in a vessel, such as a freighter, with seawater or freshwater each serving as ballast water to stabilize the vessel when the vessel carries no cargo. Here, the seawater or freshwater utilized as the ballast water contains many microorganisms and germs. The microorganisms and germs had been internationally concerned to give a negative influence on the marine ecosystem, and therefore the International Maritime Organization (IMO) adopted the Ballast Water Management Convention in 2004. This convention regulates the upper limit of the number of organisms contained in ballast water which is discharged from a vessel. The ballast water is required to be sterilized to satisfy the regulation.

Ways of killing organisms contained in the seawater or freshwater include putting a chemical agent into the water, radiating ultraviolet rays thereto, or the like. One specific way is sterilization treatment of introducing a sterilizing agent into the seawater or the freshwater through a pipe extending from a chemical agent tank, the pipe being connected to a pipe leading to a ballast tank.

Alternatively, another specific way is ballast water treatment of putting, as a sterilizing agent, a solid trichloroisocyanuric acid in a plastic chemical container, if necessary, and immersing the container in ballast water contained in a ballast tank (see Patent Literature 1). This way can sustain a sterilization effect for a long period by gradually increasing a chlorine concentration in the ballast water.

### CITATION LIST

### Patent Literature

Patent Literature 1: Japanese Unexamined Patent Publication No. 2016-198698

### SUMMARY OF INVENTION

Sterilization treatment for ballast water is performed with various aims at various timings. Examples of the aims include an aim of raising a chlorine concentration to reach a chlorine concentration reference value through putting of a sterilizing agent immediately after filing of ballast water, an aim of keeping the chlorine concentration reference value through intermittent putting of the sterilizing agent on a voyage, and an aim of killing microorganisms or germs through putting of the sterilizing agent immediately before discharging of the ballast water to thereby raise the chlorine concentration in a very short time. A worker (e.g., vessel crew) needs to execute the sterilization of the ballast water while appropriately adjusting the chlorine concentration in the ballast water to reach a target chlorine concentration at a desired rise speed depending on each aim for use.

However, the worker needs to do or perform many works or operations during a stop of the vessel. Hence, when the worker uses a normal sterilization treatment system for the ballast water, it is difficult for the worker to concentrate only on an operation of the system while appropriately and finely adjusting the chlorine concentration in the ballast water in the ballast tank. Furthermore, the chlorine concentration, to be adjusted by using the sterilizing agent, in the ballast water in the ballast tank is remarkably higher than a chlorine concentration in use of a chlorine-based chemical agent for a sterilizing purpose in a normal domestic daily life. Moreover, the sterilizing agent for the ballast water treatment often has higher sterilization performance than the chlorine-based sterilizing agent for use in the normal daily life. Under the circumstances, the worker finds difficulty in readily handling the sterilizing agent under fine control thereof for adjusting the chlorine concentration in the ballast water in the ballast tank.

From these perspectives, it is preferable that the worker can easily adjust the chlorine concentration in the ballast water in the ballast tank to meet the various aims at the various timings in the sterilization treatment for the ballast water.

Accordingly, the present invention has an object of providing a ballast water treatment pack which enables easier adjustment of a chlorine concentration in ballast water in a ballast tank.

As a result of various conducted studies to solve the above-described drawback, the present inventor has achieved the present invention.

Specifically, a ballast water treatment pack according to one aspect of the present invention comprises: a chlorine-based sterilizing agent; and a wrapper formed of a water-soluble film or a water-soluble fiber entangled body for wrapping the chlorine-based sterilizing agent.

### BRIEF DESCRIPTION OF DRAWINGS

FIG. 1 is a cross-sectional view showing a configuration of a ballast water treatment pack according to an embodiment of the present invention.

FIG. 2 is a block diagram showing a configuration of a ballast water treatment system according to an embodiment of the present invention.

FIG. 3 is a flowchart for explaining the ballast water treatment system according to the embodiment of the present invention.

### DESCRIPTION OF EMBODIMENTS

Hereinafter, embodiments according to the present invention will be described in detail. The scope of the present invention is not limited to the embodiments described hereafter, and various changes may be made without affecting the gist of the present invention.

<Ballast Water Treatment Pack>

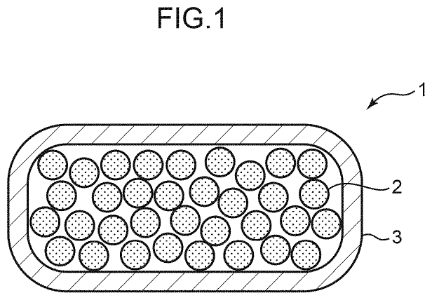

FIG. 1 is a cross-sectional view showing a configuration of a ballast water treatment pack according to an embodiment of the present invention. Denoted by respective reference numerals in FIG. 1 are a ballast water treatment pack 1, a chlorine-based sterilizing agent 2, and a wrapper 3. As shown in the cross-sectional view in FIG. 1, the ballast water treatment pack 1 in the embodiment comprises the chlorine-based sterilizing agent 2 (having a granular shape in FIG. 1), and the wrapper 3 formed of a water-soluble film or a water-soluble fiber entangled body for wrapping the chlorine-based sterilizing agent 2.

The ballast water treatment pack 1 is put into ballast water in a ballast tank, and the wrapped chlorine-based sterilizing agent 2 starts to dissolve in the ballast water when the wrapper 3 formed of the water-soluble film or the water-soluble fiber entangled body dissolves. As a result, a chlorine concentration in the ballast water rises, thereby the microorganisms or germs existing in the ballast water can be killed. Meanwhile, the chlorine concentration in the ballast water is lowered due to transpiration, separation, and reaction with a dissolved organic matter over time. Therefore, the ballast water treatment pack 1 is put into the ballast water in the ballast tank in consideration of such lowering.

The chlorine concentration (mg/L) which is a variable item of the ballast water treatment in the ballast tank is measurable through conversion to a Total Residual Oxidant (TRO) concentration (mg/L). The TRO concentration is measurable by a measurement device using a DPD reagent.

Hereinafter, respective structural elements will be described in detail.

[Chlorine-Based Sterilizing Agent]

A chlorine-based sterilizing agent comprised in the ballast water treatment pack according to the embodiment is a substance containing chlorine in its molecules. Specifically, the chlorine-based sterilizing agent is not particularly limited as long as the chlorine-based sterilizing agent exerts sterilization, sanitization, or disinfection against microorganisms or germs existing in ballast water, particularly, against microorganisms or germs existing in the seawater or freshwater. More specifically, the chlorine-based sterilizing agent is a chemical agent which is solid under an environment at a room temperature and a normal humidity, and is configured to raise a chlorine concentration when dissolving in water. In this description, the environment at the room temperature and the normal humidity means an environment at the temperature of 25° C. and the humidity of 50% RH.

As the chlorine-based sterilizing agent, for example, a compound which generates a hypochlorous acid (HOCl) or the like having sterilizing properties in water can be used. Examples of the compound which generates the hypochlorous acid or the like include a chlorinated isocyanuric acid, and calcium hypochlorite. Specific examples of the former compound include sodium dichloroisocyanurate and a trichloroisocyanuric acid.

The sodium dichloroisocyanurate of the listed two examples for the former compound is more preferably used. The sodium dichloroisocyanurate is a compound which is solid under the environment at the room temperature and the normal humidity. The reason why the sodium dichloroisocyanurate is more preferable lies in the fact that the sodium dichloroisocyanurate has a high-water dissolution rate, and thus can raise the chlorine concentration in the ballast water in a short time. In other words, a worker having determined the necessity of raising the chlorine concentration in the ballast water in the ballast tank can rapidly raise the chlorine concentration in the ballast water by putting the necessary number of ballast water treatment packs according to the embodiment. Particularly, a desired chlorine concentration is attained in a short time even in a ballast tank provided with no stirrer. Furthermore, the sodium dichloroisocyanurate is advantageous in being less likely to form a precipitate when dissolving in water, and further having excellent storability even at a high temperature of around 40° C.

Alternatively, another chlorine-based sterilizing agent, such as the trichloroisocyanuric acid having a property opposite to that of the sodium dichloroisocyanurate, i.e., having a low dissolution rate in water, may be used to sustain a sterilization effect for a long time.

The shape of the chlorine-based sterilizing agent is not particularly limited as long as the sterilizing agent can be wrapped by a water-soluble film or water-soluble fiber entangled body to be described later. Specifically, the shape of the chlorine-based sterilizing agent may be appropriately determined depending on a desired rise speed of the chlorine concentration, and a size, a thickness, and a shape of a wrapper to be described later. For instance, the sterilizing agent may have a granular shape, a tablet shape, or a powder shape. Among these shapes, the granular or tablet shape with a diameter of 0.1 mm or more and 100 mm or less is preferable from the viewpoint of handleability. Furthermore, among these shapes, the granular shape is preferably adopted, for example, in an attempt to raise the chlorine concentration in the ballast water in a short time or in a case where a management temperature of the ballast water in the ballast tank is high (i.e., in a case where the chlorine concentration in the ballast water is lowered and the microorganisms or germs are highly likely to increase again). Alternatively, the tablet shape is preferably adopted in an attempt to sustain the sterilization effect for a relatively long time or in a case where the management concentration in the ballast water is low.

If the chlorine-based sterilizing agent having the particles of the granular shape is used, the particles of the chlorine-base sterilizing agent preferably have an average particle diameter of 0.1 mm or more and 5 mm or less. Here, the average particle diameter means an average value obtained by measuring respective diameters of ten particles by a ruler. The average particle diameter of the chlorine-based sterilizing agent is more preferably 0.15 mm or more, even more preferably 0.17 mm or more, and still even more preferably 0.2 mm or more. The average particle diameter is more preferably 4 mm or less, even more preferably 3 mm or less, and still even more preferably 2 mm or less. The sterilization effect is sustainable to some extent by setting the average particle diameter of the chlorine-based sterilizing agent to 0.1 mm or more. The chlorine concentration is raisable in a shorter time by setting the average particle diameter of the chlorine-based sterilizing agent to 5 mm or less.

A mass of the chlorine-based sterilizing agent comprised per ballast water treatment pack according to the embodiment is not particularly limited. Specifically, the mass may be set suitably for a type of the aforementioned chlorine-based sterilizing agent, a size of the wrapper to be described later, a size of the ballast tank, an amount of the ballast water, and a desired rise rate of the chlorine concentration. More specifically, the mass of the chlorine-based sterilizing agent comprised per ballast water treatment pack 1 is settable to a value of several grams to several hundred grams. For instance, when 100 g chlorine-based sterilizing agent is required to be put into the ballast water in the ballast tank, one ballast water treatment pack comprising 100 g chlorine-based sterilizing agent is put thereinto satisfactorily to meet the requirement. Alternatively, for instance, ten ballast water treatment packs each comprising 10 g chlorine-based sterilizing agent is put thereinto satisfactorily to meet the requirement. As described above, the mass of the chlorine-based sterilizing agent comprised per ballast water treatment pack according to the embodiment is appropriately adjustable, and the number of the packs to be put in is also appropriately settable.

In a specific example using the aforementioned sodium dichloroisocyanurate as the chlorine-based sterilizing agent, the mass required for the ballast water treatment in the ballast tank is determined depending on an amount of the ballast water and a predetermined chlorine concentration reference value (see embodiments respectively relevant to a ballast water treatment system and a ballast water treatment method to be described later). Regarding the chlorine concentration in the ballast water, for example, the mass of the sodium dichloroisocyanurate (in a case of 55% chlorine concentration) necessary for the treatment of 100 t of the ballast water having the TRO concentration of 10 mg/L is calculated as 1.82 kg from the following Equation:

10(mg/L)×100(m³)/0.55=1.82(kg)

In a more specific example, 20 t of ballast water is filled into the ballast tank, and the predetermined chlorine concentration reference value indicates the TRO concentration of 10 mg to 20 mg/L. In this case, the necessary amount of sodium dichloroisocyanurate based on the aforementioned equation results in 364 g to 727 g. In adoption of a ballast water treatment pack comprising 100 g sodium dichloroisocyanurate, four to seven packs are needed. In adoption of a ballast water treatment pack comprising 50 g sodium dichloroisocyanurate, eight to fourteen packs are needed.

[Wrapper Formed of Water-Soluble Film or Water-Soluble Fiber Entangled Body]

In the ballast water treatment pack according to the embodiment, the chlorine-based sterilizing agent is wrapped by a wrapper formed of a water-soluble film or a water-soluble fiber entangled body.

The water-soluble film is not particularly limited, and may be made of substance having solubility in water. The water-soluble film preferably fully dissolves without forming any precipitate in the ballast tank finally, or a large portion thereof may dissolve to allow the chlorine-based sterilizing agent inside to dissolve out.

Examples of the water-soluble film include a film made of raw material, such as polyvinyl alcohol, starch, cellulose, a polyacrylic acid, polyacrylamide, and polyoxyethylene. The raw materials listed above may be used alone or in combination of two or more of them. Moreover, a polyvinyl alcohol film made of polyvinyl alcohol as the raw material among them is preferable in view of its durability, chlorine resistance, cost performance, and easier adjustment of properties thereof including water-solubility.

The water-soluble fiber entangled body is not particularly limited, and may be formed of fibers made of raw material having solubility in water. Specifically, examples of the water-soluble fiber entangled body include a water-soluble nonwoven fabric, a water-soluble knitted fabric, and a combination of both the fabrics. The water-soluble fiber entangled body preferably fully dissolves without forming any precipitate in the ballast tank finally, or a large portion thereof may dissolve to allow the chlorine-based sterilizing agent inside to dissolve out.

Examples of the water-soluble fiber entangled body may include a fiber entangled body consisting fibers made of raw material, such as polyvinyl alcohol, starch, cellulose, a polyacrylic acid, polyacrylamide, and polyoxyethylene. The raw materials listed above may be used alone or in combination of two or more of them. Moreover, a water-soluble fiber entangled body consisting fibers made of polyvinyl alcohol as the raw material among them is preferable in view of its durability, chlorine resistance, cost performance, and easier adjustment of properties thereof including water-solubility.

The polyvinyl alcohol is in the form of a polymer having a vinyl alcohol unit (—CH₂—CH (OH)—) as a main structural unit. In the description, the polyvinyl alcohol may have a vinyl ester unit or another unit other than the vinyl alcohol unit.

The polyvinyl alcohol is obtainable by saponifying a polyvinyl ester obtained by polymerizing a vinyl ester. Examples of the vinyl ester include vinyl acetate, vinyl formate, vinyl propionate, vinyl butyrate, vinyl pivalate, vinyl versatate, vinyl laurate, vinyl stearate, vinyl benzoate, and isopropenyl acetate. Two or more kinds of the vinyl ester may be used and polymerized. Among them, the vinyl acetate is preferable in view of its easy productivity, high availability, and cost performance. More preferably, the vinyl acetate is solely used as the vinyl ester for polymerization.

The polyvinyl ester may contain another monomer which is co-polymerizable with the vinyl ester unless the monomer ruins the water-solubility of the finally produced polyvinyl alcohol. Examples of the monomer include: olefin, such as ethylene, propylene, 1-butene, and isobutene; an (metha) acrylamide alkyl sulfonic acid, such as a 2-acrylamide-2-methylpropanesulfonic acid, or a salt thereof; an unsaturated carboxylic acid, such as a maleic acid, an itaconic acid, and an (metha) acrylic acid, or an ester thereof, or a salt thereof. That is to say, the polyvinyl ester may have a structural unit derived from one or more kinds of these monomers.

A part of a hydroxy group of the polyvinyl alcohol may be crosslinked or may not be crosslinked. A part of the hydroxy group of the polyvinyl alcohol may react with an aldehyde compound, such as acetaldehyde and butyl aldehyde, to form an acetal structure.

The solubility of the polyvinyl alcohol in water is adjustable owing to adjustment of a degree of saponification, typically, adjustment of a proportion (mol %) of the number of moles of the vinyl alcohol unit to the total number of moles of the vinyl ester unit and those of the vinyl alcohol unit. The range of the degree of saponification is preferably 60 mol % or more to 98 mol % or less. The degree of saponification is more preferably 65 mol % or more, even more preferably 70 mol % or more, and still even more preferably 75 mol % or more, 78 mol % or more, or 80 mol % or more. Additionally, the degree of saponification is more preferably 95 mol % or less, even more preferably 93 mol % or less, still even more preferably 90 mol % or less, less than 88 mol %, or 85 mol % or less. Adjustment of the degree of saponification to fall within the range in this manner is preferable for excellent solubility in the seawater (ballast water) having a large temperature range of around 10° C. to 20° C. in a sea area where the vessel advances. The degree of saponification of the polyvinyl alcohol is measurable in accordance with the description in JIS-K-6726:1994.

A viscosity of polyvinyl alcohol in a 4% aqueous solution at 20° C. is preferably 1 mPa·s or more, more preferably 2 mPa·s or more, even more preferably 3 mPa·s or more, and still even more preferably 4 mPa·s or more. A increase in the viscosity of the polyvinyl alcohol can suppress film formation failure in producing the film or formation failure in forming a fiber made of polyvinyl alcohol as a raw material. The viscosity of the polyvinyl alcohol in the 4% aqueous solution at 20° C. is preferably 20 mPa s or less, more preferably 15 mPa·s or less, even more preferably 10 mPa·s or less, and still even more preferably 8 mPa·s or less. A decrease in the viscosity of the polyvinyl alcohol can improve the flexibility of the polyvinyl alcohol film or of the fiber made of polyvinyl alcohol. The viscosity of the polyvinyl alcohol is measurable in accordance with the description in JIS K6726:1994.

Besides, a degree of polymerization of the polyvinyl alcohol is preferably 300 or more, more preferably 500 or more, and even more preferably 1000 or more. The polyvinyl alcohol having the degree of polymerization of 300 or more can improve the flexibility of the polyvinyl alcohol film or of the fiber made of polyvinyl alcohol as a raw material. Moreover, the degree of polymerization of the polyvinyl alcohol is preferably 5000 or less, more preferably 3000 or less, and even more preferably 2500 or less. The polyvinyl alcohol having the degree of polymerization of 5000 or less can suppress an increase in the cost of producing polyvinyl alcohol, and film formation failure in producing the film or formation failure in forming the fiber made of polyvinyl alcohol as a raw material. The degree of polymerization of the polyvinyl alcohol is measurable in accordance with an average degree of polymerization of the polyvinyl alcohol described in JIS K6726:1994.

As described heretofore, adjustment of each of the degree of saponification, the viscosity, and the average degree of polymerization of the polyvinyl alcohol serving as the raw material of the water-soluble film or the fiber of the water-soluble fiber entangled body leads to successful and appropriate adjustment about solubility of the water-soluble film or of the water-soluble fiber entangled body in the ballast water and a degree of freedom in the formation of the film or the water-soluble fiber entangled body. Particularly, this adjustment is easily available at a low cost in use of the polyvinyl alcohol as a raw material of the film or the fiber, and thus is preferable.

A wrapper formed of the water-soluble film will be described in more details.

The water-soluble film is producible by employing an arbitrary way known to a person skilled in the art with use of a water-soluble substance serving as a raw material. The way of producing the film is not particularly limited, but examples of the way include a roll-coating way, a reverse-coating way, a comma coating way, a knife-coating way, a die-coating way, a gravure-coating way, a melt-extrusion molding way, a solution casting way, a T-die way, and a calendar way. Alternatively, a water-soluble film having an increased thickness or a stack of multilayered water-soluble films made of different raw materials is producible by employing a co-extrusion way or a lamination way. If necessary, an additive for typical use, such as a coloring agent, a perfume, an extender, a defoaming agent, a remover, an ultraviolet absorber, an inorganic powder agent, a surfactant, an antiseptic agent, an antifungal agent, and a surfactant or a dispersant for improvement in affinity or in uniform disperse to the water may be appropriately added in producing the water-soluble film.

The water-soluble film produced in this manner may have a preferable thickness adjusted suitably for a difference in a kind of a water-soluble substance serving as a raw material, a type and a shape of the chlorine-based sterilizing agent wrapped inside, a desired dissolution rate of the film, and a shape of the wrapper formed of the film. More specifically, the thickness of the water-soluble film may be sufficient to avoid a risk of skin inflammation which would be caused by the chlorine-based sterilizing agent inside the film when a person touches the chlorine-based sterilizing agent with his/her hand via the water-soluble film. In the description, for a configuration including multilayered water-soluble films made of different raw materials, the meaning of “the thickness of the water-soluble film” covers a total thickness of the multilayered films.

The thickness of the water-soluble film is, for example, preferably 5 μm or more, more preferably 10 μm or more, even more preferably 15 μm or more, still even more preferably 20 μm or more, 30 μm or more, 40 μm or more, 50 μm or more, or 60 μm or more. The larger thickness of the water-soluble film can attain more safer wrapping of the chlorine-based sterilizing agent. Besides, the thickness of the water-soluble film is not particularly limited, but is, for example, preferably 1000 μm or less, more preferably 800 μm or less, even more preferably 600 μm or less, still even more preferably 400 μm or less, 200 μm or less, 100 μm or less, or 80 μm or less. The smaller thickness of the water-soluble film can achieve dissolution of the film in a shorter time, and consequently, attain a rise in the chlorine concentration in the ballast water in a much shorter time after putting of the ballast water treatment pack. Particularly, a much smaller thickness of the water-soluble film and use of a compound, as the chlorine-based sterilizing agent, having a high dissolution rate in water like the aforementioned sodium dichloroisocyanurate can achieve a synergistic increase in the rise speed of the chlorine concentration in the ballast water in the ballast tank. Such a ballast water treatment pack can efficiently kill microorganisms or germs existing in the ballast water through putting of the pack into the ballast water at a time immediately before discharging of the water.

A wrapper formed of the water-soluble fiber entangled body will be described in more details.

The water-soluble fiber entangled body is producible by employing an arbitrary way known to a person skilled in the art with use of a fiber of a water-soluble substance serving as a raw material.

For instance, first, a fiber of a water-soluble substance is produced from the water-soluble substance serving as the raw material by a melt spinning way, a wet spinning way, a dry spinning way, or other way. In producing of the fiber, the fiber may be stretched if necessary, or may be further crimped and wound by a crimp imparting device if necessary. The fiber may have a fineness degree set to a desired value suitably for a molding way, a thickness of the water-soluble fiber entangled body to be described later, and the like. Alternatively, another additive may be appropriately blended in addition to the fiber of the water-soluble substance serving as the raw material for the water-soluble fiber entangled body. Examples of the additive include a plasticizer, a filler, and a lubricant.

The way of producing a water-soluble nonwoven fabric is not particularly limited, and an arbitrary way known to the person skilled in the art can be employed to produce the water-soluble nonwoven fabric. For instance, the water-soluble nonwoven fabric is producible by employing a spun-bond way, a melt-blown way, or other way using water-soluble fibers produced in the aforementioned manner, or employing a way of forming pieces of the fibers obtained through cutting at a predetermined length into a web by a dry way, such as a carding way and an air-laid way. The way of producing a water-soluble knitted fabric is not particularly limited, and an arbitrary knitting way known to the person skilled in the art can be employed to produce the water-soluble knitted fabric. An appropriate change in the basis weight (g/cm²) (or density) of the water-soluble nonwoven fabric or the water-soluble knitted fabric can lead to adjust the strength or the like of the water-soluble fiber entangled body. Water-soluble nonwoven fabrics containing different kinds of fibers may be adhered to each other or laid on one another by heating, or fibers made of different kinds of raw materials may be knitted together to form a single water-soluble fiber entangled body. Alternatively, an arbitrary number of water-soluble nonwoven fabrics and an arbitrary number of water-soluble knitted fabrics may be laid on one another to form a single water-soluble fiber entangled body. If necessary, an additive for typical use, such as a coloring agent, a perfume, an extender, a defoaming agent, a remover, an ultraviolet absorber, an inorganic powder agent, a surfactant, an antiseptic agent, an antifungal agent, and a surfactant or a dispersant for improvement in affinity or in uniform disperse to the water may be appropriately added in producing the water-soluble fiber entangled body. Further alternatively, with the aim of improving the strength, another water-soluble film or the like made of raw material similar to the water-soluble fiber entangled body may be further laid on so as to form a single water-soluble fiber entangled body.

The water-soluble fiber entangled body produced in this manner may have a preferable thickness (a preferable average thickness in consideration of protrusions and recesses on a surface of the entangled body when the entangled body has such surface) adjusted suitably for a difference in a kind and a fineness degree (dtex) of the fiber of the water-soluble substance serving as the raw material and a basis weight (g/cm²) (or density) of the fiber entangled body, a type and a shape of the chlorine-based sterilizing agent wrapped inside, a desired dissolution rate of the fiber entangled body, and a shape of the wrapper formed of the fiber entangled body. More specifically, the thickness of the water-soluble fiber entangled body may be sufficient to avoid a risk of skin inflammation which would be caused by the chlorine-based sterilizing agent contained inside the composite even when a person touches the chlorine-based sterilizing agent with his/her hand via the water-soluble fiber entangled body. In the description, for a configuration including multilayered water-soluble fiber entangled bodies made of different raw materials, the meaning of “the thickness of the water-soluble fiber entangled body” covers a total thickness of the multilayered entangled bodies.

The thickness of the water-soluble fiber entangled body is, for example, preferably 5 μm or more, more preferably 10 μm or more, even more preferably 20 μm or more, still even more preferably 30 μm or more, 40 μm or more, 50 μm or more, 60 μm or more, or 70 μm or more. The larger thickness of the water-soluble fiber entangled body can attain more safely wrapping of the chlorine-based sterilizing agent. Furthermore, the thickness of the water-soluble fiber entangled body is not particularly limited, but is, for example, preferably 2000 μm or less, more preferably 1500 μm or less, even more preferably 1300 μm or less, still even more preferably 1000 μm or less, 800 μm or less, 500 μm or less, or 100 μm or less. The smaller thickness of the water-soluble fiber entangled body can achieve dissolution of the fiber entangled body in a shorter time, and consequently, attain a rise in the chlorine concentration in the ballast water in a much shorter time after putting of the ballast water treatment pack. Particularly, a much smaller thickness of the water-soluble fiber entangled body and use of a compound, as the chlorine-based sterilizing agent, having a high dissolution rate in water like the aforementioned sodium dichloroisocyanurate can achieve a synergistic increase in the rise speed of the chlorine concentration in the ballast water in the ballast tank. Such a ballast water treatment pack can efficiently kill microorganisms or germs existing in the ballast water through putting of the pack into the ballast water at a time immediately before discharging of the water.

The wrapper is formed of the water-soluble film or the water-soluble fiber entangled body. In the description, the thickness of the aforementioned water-soluble film or the water-soluble fiber entangled body and the thickness of the wrapper matche each other. The shape of the wrapper is not particularly limited as long as the wrapper can appropriately wrap the chlorine-based sterilizing agent. Examples of the shape of the wrapper include a bag-like shape, such as a drawstring bag shape, and a spherical shape having a hollow inside for receiving the chlorine-based sterilizing agent therein. A way of producing the wrapper is not particularly limited, and the wrapper is producible by, for example, folding the aforementioned water-soluble film and appropriately fusing facing and overlapped ends of the film to each other into a bag-like shape, or folding the aforementioned water-soluble fiber entangled body and appropriately fusing facing and overlapped ends of the composite into a bag-like shape. The size of the wrapper is not particularly limited as long as the wrapper can appropriately wrap the chlorine-based sterilizing agent. The chlorine-based sterilizing agent may fill an inner part of the wrapper at a time before an opening of the wrapping is finally closed to produce the ballast water treatment pack.

The number of ballast water treatment packs or a total amount thereof according to the embodiment to be put into the ballast water in the ballast tank may be determined to fall within a corresponding range for passing a test regulated by the Ballast Water Management Convention, at the time of putting of the pack. Specifically, an upper limit and a lower limit of the number of or the total amount of packs to be put in is determinable depending on the sterilizing performance or corrosion resistance of the chlorine-based sterilizing agent comprised per pack. For instance, the TRO concentration is preferably 2 mg/L or more, more preferably 3 mg/L or more, even more preferably 5 mg/L or more. Besides, for example, the TRO concentration is preferably 30 mg/L or less, more preferably 20 mg/L or less, even more preferably 10 mg/L or less in consideration of suppressing corrosion of a material of the ballast tank. It is seen from these perspectives that ballast water in a ballast tank generally has a relatively high chlorine concentration reference value, and therefore needs a large amount of the chlorine-based sterilizing agent. In contrast, adoption of the ballast water treatment pack according to the embodiment permits putting of a large number of ballast water treatment packs each having a reduced weight owing to a reduced mass per pack as described above, resulting in achieving a further reduction in the burden on the worker.

Conclusively, the ballast water treatment pack according to the embodiment ensures the sufficient sealing performance, durability, and oxidation resistance in its individual packaging without losing the properties of the chlorine-based sterilizing agent included inside for a sufficiently long period. Therefore, the ballast water treatment pack is excellent in its handleability, and thus can be easily used regardless of a difference in elements, such as the size of the ballast tank. Specifically, mere putting of the ballast water treatment pack into the ballast water in the ballast tank can easily attain a rise in the chlorine concentration in the ballast water in the ballast tank. Furthermore, various combinations are selectable from the kind and the shape of the chlorine-based sterilizing agent, and the kind and the thickness of the water-soluble film (the thickness of the wrapper) or the kind and the fineness degree (dtex) of the fiber of the water-soluble fiber entangled body, the basis weight (g/cm²) (or density) of the water-soluble fiber entangled body, and the thickness of the water-soluble fiber entangled body (thickness of the wrapper). Hence, each of the rise rate and the rise speed of the chlorine concentration is appropriately adjustable to a desired value at corresponding one of various timings (e.g., at a time of water filing or a time of water discharging). Furthermore, the ballast water treatment pack can suppress a natural damage of the wrapper and leakage of the chlorine-based sterilizing agent out of the damaged wrapper. This configuration accordingly can reduce a risk that the worker inhales dusts and dangerous gas, such as chlorine gas, of the chlorine-based sterilizing agent, and further allows the worker to directly touch and handle the pack. Consequently, the chlorine concentration in the ballast water is safely and easily adjustable to a desired concentration. Particularly, a chlorine-based sterilizing agent for ballast water treatment has a higher sterilization performance than a normal chlorine-based chemical agent. Thus, the worker conventionally has found it difficult to readily handle the sterilizing agent. To overcome the situation, the worker can easily and rapidly put the chlorine-based sterilizing agent in the ballast tank at a desired timing of the worker by adopting the ballast water treatment pack according to the embodiment, resulting in attainment of a rise in the chlorine concentration.

<Ballast Water Treatment System>

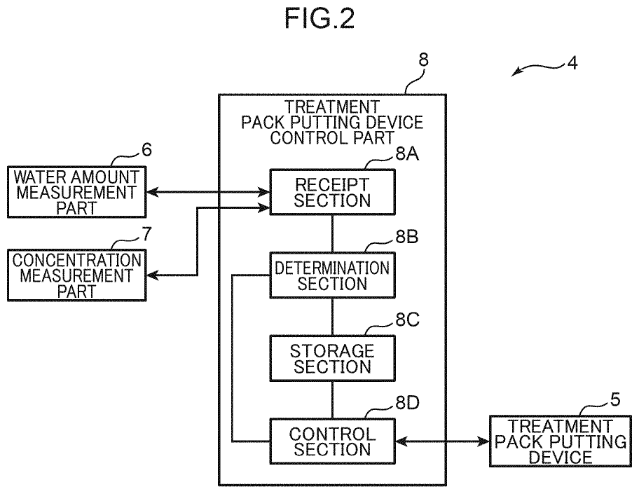

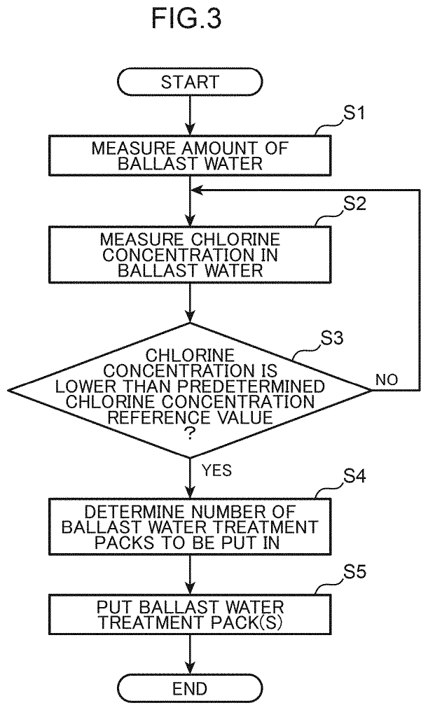

A configuration of a ballast water treatment system 4 according to an embodiment will be described with reference to FIG. 2 and FIG. 3. Denoted by respective reference numerals in FIG. 2 are the ballast water treatment system 4, a treatment pack putting device 5, a water amount measurement part 6, a concentration measurement part 7, a treatment pack putting device control part 8, a receipt section 8A, a determination section 8B, a storage section 8C, and a control section 8D.

The ballast water treatment system 4 according to the embodiment is a system for appropriately sterilizing ballast water in a ballast tank by putting the ballast water treatment pack according to the preceding embodiment by the treatment pack putting device 5.

As shown in FIG. 2, the ballast water treatment system 4 comprises the treatment pack putting device 5, the water amount measurement part 6, the concentration measurement part 7, and the treatment pack putting device control part 8. Besides, the treatment pack putting device control part 8 comprises the receipt section 8A, the determination section 8B, the storage section 8C, and the control section 8D.

The water amount measurement part 6 is a sensor for measuring an amount of the ballast water in the ballast tank, and is attached to, for example, the ballast tank of the vessel therein. First, the water amount measurement part 6 measures the amount of the ballast water (S1), and the measured amount is transmitted to the receipt section 8A of the treatment pack putting device control part 8.

The concentration measurement part 7 is a sensor for measuring a chlorine concentration in the ballast water in the ballast tank, and is attached to, for example, the ballast tank of the vessel therein. Subsequently, the concentration measurement part 7 measures the chlorine concentration in the ballast water (S2), and the measured chlorine concentration is transmitted to the receipt section 8A of the treatment pack putting device control part 8.

The amount of the ballast water and the chlorine concentration each received by the receipt section 8A is further transmitted to the determination section 8B. The determination section 8B, first, determines whether the chlorine concentration reaches a value equal to or higher than a predetermined chlorine concentration reference value stored in the storage section 8C (S3). The predetermined chlorine concentration reference value may be set to, for example, a preferable TRO concentration as described in the preceding embodiment.

When the chlorine concentration reaches the chlorine concentration reference value or higher, the concentration measurement part 7 continues to measure the chlorine concentration in the ballast water without transmission of a signal to the control section 8D (NO in S3).

In contrast, when the chlorine concentration is lower than the predetermined chlorine concentration reference value (YES in S3), the determination section 8B determines (calculates) the number of ballast water treatment packs to be put in for allowing the chlorine concentration in the ballast water in the ballast tank to reach the chlorine concentration reference value, based on the chlorine concentration and the amount of the water (S4). For the determination, the storage section 8C stores the mass of the chlorine-based sterilizing agent comprised per ballast water treatment pack 1. That is to say, the number of the packs to be put in is determined, based on the mass.

Thereafter, the determined (calculated) number is transmitted to the control section 8D, and the treatment pack putting device 5 is controlled to put the determined number of the ballast water treatment packs in the ballast tank (S5). The treatment pack putting device 5 may be any device as long as the device can put the ballast water treatment pack, for example, may be a simple putting device having an opening at a position above the ballast tank for putting ballast water treatment packs one by one into the ballast water.

In this manner, the ballast water treatment system 4 according to the embodiment can keep the chlorine concentration in the ballast water in the ballast tank at the chlorine concentration reference value or higher with its simple structure regardless of various elements, such as the size of the ballast tank and the amount of the ballast water. Moreover, the ballast water treatment system according to the embodiment needs only a small arrangement space, and thus, is applicable to an existing vessel or a vessel which faces difficulty in ensuring a sufficient arrangement space.

The determination section 8B in the ballast water treatment system 4 may determine whether the chlorine concentration is the predetermined chlorine concentration reference value or falls within a predetermined range of the chlorine concentration instead of determining whether the chlorine concentration reaches the chlorine concentration reference value or higher.

Alternatively, two or more kinds of ballast water treatment packs respectively comprising chlorine-based sterilizing agents whose masses differ from each other may be applied to the ballast water treatment system 4. In this case, the number of each kind of the ballast water treatment packs to be put in may be determined so that the chlorine concentration comes closer to the predetermined chlorine concentration reference value.

Furthermore, for example, the concentration measurement part 7 which measures the chlorine concentration in the ballast water in the ballast tank is excludable, for example, immediately after the ballast water is filled into the ballast tank.

The ballast water treatment system according to the embodiment is also applicable to filtered ballast water.

Furthermore, the storage section 8C may store, as voyage recordation, the number of the ballast water treatment packs put by the treatment pack putting device 5.

Meanwhile, in the description, the term “a water amount measurement part which measures an amount of ballast water contained in a ballast tank” covers “a water amount input part which inputs an amount of the ballast water to be put in a ballast tank” and the term “the amount of the ballast water measured by the water amount measurement part” covers “the amount of the ballast water input by the water amount input part” at a time immediately after discharging of the ballast water from the ballast tank. Alternatively, the former term further covers “a water amount measurement part which measures an amount of ballast water to be poured into a ballast tank” and the latter term further covers “the amount of the ballast water measured by the water amount measurement part”.

<Ballast Water Treatment Method>

A ballast water treatment method according to an embodiment will be described below.

First, an amount of ballast water in a ballast tank is measured. The amount of the water may be measured by, for example, a water amount measurement sensor attached to the ballast tank of the vessel therein.

Subsequently, the number of ballast water treatment packs to be put in for allowing a chlorine concentration in the ballast water in the ballast tank to reach a predetermined chlorine concentration reference value is determined, based on the measured amount of the ballast water. The predetermined chlorine concentration reference value may be defined as a preferable TRO concentration, for example, as described in the preceding embodiment.

When the chlorine concentration reaches the predetermined chlorine concentration reference value or higher, preferably, the chlorine concentration in the ballast water may be intermittently measured. In contrast, when the chlorine concentration is lower than the predetermined chlorine concentration reference value, the number of ballast water treatment packs to be put in for allowing the chlorine concentration in the ballast water in the ballast tank to reach the chlorine concentration reference value is determined (calculated), based on the chlorine concentration and the amount of the water. Regarding the determination, a CPU or a worker may determine (calculate), based on the mass of the chlorine-based sterilizing agent comprised per ballast water treatment pack, the number of packs to be put in.

Thereafter, the determined (calculated) number of the ballast water treatment packs is put in the ballast tank. The ballast water treatment pack is directly touchable for use thereof by the worker, as described in the preceding embodiment. Therefore, a putting way is not particularly limited, and the worker may directly put the ballast water treatment pack in the ballast tank.

In the same manner as the ballast water treatment system according to the preceding embodiment, the predetermined chlorine concentration reference value may be appropriately changed, two or more kinds of ballast water treatment packs respectively comprising chlorine-based sterilizing agents whose masses differ from each other may be adopted, and a step of measuring the chlorine concentration in the ballast water in the ballast tank may be omitted in the ballast water treatment method according to the embodiment, and additionally, the method is applicable to filtered ballast water as well.

In the description, the term “a step of measuring an amount of ballast water in a ballast tank” covers “a step of determining an amount of ballast water to be filled into a ballast tank” and the term “the measured amount of the ballast water” covers “the predetermined amount of the ballast water” at a time immediately after discharging of the ballast water from the ballast tank.

Conclusively, the ballast water treatment method according to the embodiment permits the worker to directly put only the necessary number of ballast water treatment packs in the ballast tank, as the simplest way, regardless of various elements, such as the size of the ballast tank and the amount of the ballast water.

Heretofore, the gist of the present invention is described, and the ballast water treatment pack according to the embodiment will be summarized below.

A ballast water treatment pack according to one aspect of the present invention comprises: a chlorine-based sterilizing agent; a wrapper formed of a water-soluble film or a water-soluble fiber entangled body for wrapping the chlorine-based sterilizing agent.

The ballast water treatment pack having this configuration can easily adjust the chlorine concentration in the ballast water in the ballast tank.

In the ballast water treatment pack, the chlorine-based sterilizing agent preferably contains sodium dichloroisocyanurate.

In the ballast water treatment pack, the wrapper is preferably formed of the water-soluble film which is a polyvinyl alcohol film.

In the ballast water treatment pack, the wrapper is preferably formed of the water-soluble film having a thickness of 10 μm or more and 100 μm or less.

Alternatively, in the ballast water treatment pack, the wrapper is preferably formed of the water-soluble fiber entangled body consisting fibers made of polyvinyl alcohol as a raw material.

In the ballast water treatment pack, the wrapper is preferably formed of the water-soluble fiber entangled body having a thickness of 10 μm or more and 1000 μm or less.

In the ballast water treatment pack, particularly, the chlorine-based sterilizing agent preferably has a granular shape with an average granular diameter of 0.1 mm or more and 5 mm or less.

A ballast water treatment system according to another aspect of the present invention is provided with a treatment pack putting device. The system comprises: a water amount measurement part which measures an amount of ballast water contained in a ballast tank; and a treatment pack putting device control part which determines, based on the amount of the ballast water measured by the water amount measurement part, the number of ballast water treatment packs according to the aforementioned aspect to be put in so that a chlorine concentration in the ballast water in the ballast tank reaches a predetermined chlorine concentration reference value, and controls the treatment pack putting device to put the determined number of the ballast water treatment packs in the ballast tank.

The ballast water treatment system having this configuration can raise the chlorine concentration in the ballast water to a target chlorine concentration at a rise speed desired by the worker while ensuring the safety of the worker.

The ballast water treatment system preferably further comprises a concentration measurement part which measures the chlorine concentration in the ballast water in the ballast tank. The treatment pack putting device control part preferably determines, further based on the chlorine concentration measured by the concentration measurement part, the number of the ballast water treatment packs to be put in.

A ballast water treatment method according to further another aspect of the present invention comprises: a step of measuring an amount of ballast water in a ballast tank; a step of determining, based on the measured amount of the ballast water, the number of ballast water treatment packs according to the aforementioned aspect to be put in so that a chlorine concentration in the ballast water in the ballast tank reaches a predetermined chlorine concentration reference value; and a step of putting the determined number of the ballast water treatment pack in the ballast tank.

The ballast water treatment method adopting this configuration attains a rise in the chlorine concentration in the ballast water to a target chlorine concentration at a rise speed desired by the worker while ensuring the safety of the worker.

The ballast water treatment method preferably further comprises a step of measuring the chlorine concentration in the ballast water in the ballast tank. In the step of determining, the number of ballast water treatment packs to be put in is preferably determined, further based on the measured chlorine concentration.

### EXAMPLES

Hereinafter, the present invention will be described in more details with reference to Examples, but the scope of the present invention is not limited due to the Examples.

### Example 1

First, 500 L of river water was poured into a plastic tank simulating a ballast tank and having a volume of 1 m³. The filtered water (ballast water) had a temperature of 15° C. Tetracelmis (having a minimum diameter of around 10 μm to 15 μm) which is one genus of phytoplankton was put into the ballast water as an indicator species to be 1000 individuals/cm³ of the ballast water.

Then, a ballast water treatment pack sample was prepared. Sodium dichloroisocyanurate in the form of granules each having a particle diameter of 200 μm to 2000 μm (produced by Occidental Chemical Corporation, with the product name “ACL 56”) was measured to reach 20 g and put in a bag-like water-soluble film, and then an opening of the film was closed by way of thermal fusion after the putting to provide a wrapper. The water-soluble film was made of, as a raw material, polyvinyl alcohol (having a 88 mol % degree of saponification, and a viscosity of 5 mPa·s in a 4% water solution at a temperature of 20° C.) and had a thickness of 20 μm by the roll-coating way.

The ballast water treatment pack sample prepared in this manner was put in the aforementioned plastic tank. At this time, there was no occurrence of dusts attributed to the granules of the sodium dichloroisocyanurate and no chlorine odor from the ballast water treatment pack sample. Thereafter, the ballast water in the plastic tank was taken after 15 minutes, 30 minutes, and 60 minutes respectively from the putting of the ballast water treatment pack sample.

The TRO concentration (mg/L) in the ballast water taken after each elapsed time in this manner was measured by a DPD-type colorimeter II manufactured by HACH Company.

Furthermore, a state of the water-soluble film of the ballast water treatment pack sample in each elapsed time was visually observed. Additionally, the number of surviving individuals of the tetracelmis (ind/cm³) in the ballast water taken after the lapse of 60 minutes was measured through visual observation under a 20-fold microscope (a moving individual was determined as a surviving individual here).

The measurement results are shown in Table 1 below.

TABLE 1

| Elapsed time (min.) | 0 | 15 | 30 | 60 |
|---|---|---|---|---|
| TRO concentration | 0 | 7.5 | 12 | 18 |
| (mg/L) | | | | |
| State of | — | Around | A large | Dissolved |
| water-soluble film | | 2/3 | portion | |
| | | dissolved | dissolved | |
| Number of | 1.0 × 10³ | — | — | 0 |
| existing | | | | |
| individuals | | | | |
| (ind/cm³) | | | | |

As seen from Table 1, the TRO concentration (mg/L) in the ballast water rose over time after the ballast water treatment pack sample was put into the ballast water. Moreover, a large portion of the water-soluble film of the ballast water treatment pack sample dissolved in around 30 minutes, and further the film dissolved to be invisible after 60 minutes. Furthermore, extermination of the phytoplankton (tetracelmis) in the ballast water was confirmed after the lapse of 60 minutes from the putting. In this respect, it is considered that sodium dichloroisocyanurate started to dissolve out in the ballast water and chlorine came into existence as a result of the dissolution of the water-soluble film, and thus the TRO concentration (mg/L) rose, and consequently, killing action on the microorganisms or germs in the ballast water increased.

### Example 2

Next, 700 L of filtered river water was poured into a plastic tank simulating a ballast tank and having a volume of 1 m³. The filtered water (ballast water) had a temperature of 16° C. Tetracelmis (having a minimum diameter of around 10 μm to 15 μm) which is one genus of phytoplankton was put into the ballast water as an indicator species to be 1000 individuals/cm³ of the ballast water.

Then, another ballast water treatment pack sample was prepared. Sodium dichloroisocyanurate in the form of granules each having a particle diameter of 200 μm to 2000 μm (produced by Occidental Chemical Corporation, with the product name “ACL 56”) was measured to reach 20 g and put in a bag-like water-soluble nonwoven fabric, and then an opening of the fabric was closed by way of thermal fusion after the putting to provide a wrapper. For the water-soluble nonwoven fabric, polyvinyl alcohol fibers (each having a single yarn fineness degree of 2.0 dtex) was obtained by stretching spinning yarns made of, as a raw material, polyvinyl alcohol (having a 88 mol % degree of saponification, and a viscosity of 5 mPa·s in a 4% water solution at a temperature of 20° C.) by twice in a hot-blast furnace at 160° C. The obtained fibers were crimped, and cut into staples and then performed carding to be formed into a web, so that a nonwoven fabric having a basis weight of 35 g/cm² and an average thickness of 50 μm was obtained.

The ballast water treatment pack sample prepared in this manner was put in the aforementioned plastic tank. At this time, there was no occurrence of dusts attributed to the granules of the sodium dichloroisocyanurate and no chlorine odor from the ballast water treatment pack sample. Thereafter, the ballast water in the plastic tank was taken after 10 minutes, 20 minutes, and 30 minutes respectively from the putting of the ballast water treatment pack sample.

The TRO concentration (mg/L) in the ballast water taken after each elapsed time in this manner was measured by the DPD-type colorimeter II manufactured by HACH Company. Furthermore, a state of the water-soluble nonwoven fabric of the ballast water treatment pack sample in each elapsed time was visually observed. Additionally, the number of surviving individuals of the tetracelmis (ind/cm³) in the ballast water taken after the lapse of 30 minutes was measured through visual observation under a 20-fold microscope (a moving individual was determined as a surviving individual here).

The measurement results are shown in Table 2 below.

TABLE 2

| Elapsed time (min.) | 0 | 10 | 20 | 30 |
|---|---|---|---|---|
| TRO concentration | 0 | 6.8 | 10 | 13 |
| (mg/L) | | | | |
| State of | — | A large | Almost | Dissolved |
| water-soluble | | portion | dissolved | |
| nonwoven fabric | | dissolved | | |
| Number of | 1.0 × 10³ | — | — | 0 |
| existing | | | | |
| individuals | | | | |
| (ind/cm³) | | | | |

As seen from Table 2, the TRO concentration (mg/L) of the ballast water rose over time after the ballast water treatment pack sample was put into the ballast water. Moreover, the water-soluble nonwoven fabric of the ballast water treatment pack sample almost dissolved in around 20 minutes, and further dissolved to be invisible after 30 minutes. Furthermore, extermination of the phytoplankton (tetracelmis) in the ballast water was confirmed after the lapse of 30 minutes from the putting. In this respect, it is considered that sodium dichloroisocyanurate started to dissolve out in the ballast water and chlorine came into existence as a result of the dissolution of the water-soluble nonwoven fabric, and thus the TRO concentration (mg/L) rose, and consequently, killing action on the microorganisms or germs in the ballast water increased.

This application is based on Japanese Patent Application No. 2019-238176 filed in Japan Patent Office on Dec. 27, 2019, and based on Japanese patent application No. 2019-238177 filed in Japan Patent Office on Dec. 27, 2019, the entire disclosure of which are hereby incorporated by reference.

Although the present invention has been fully described by way of the embodiments and examples with reference to the above-described specific examples, it is to be understood that various changes and/or modifications to the embodiments and examples will be apparent to those skilled in the art. Therefore, unless otherwise such changes and modifications to be made by those skilled in the art depart from the scope of the present invention hereinafter defined, they should be construed as being included therein.

### INDUSTRIAL APPLICABILITY

According to the present invention, a chlorine concentration in ballast water in a ballast tank is easily adjustable in a technical field related to treatment agents for use in treatment, such as sterilization treatment, of the ballast water in the ballast tank. Accordingly, the present invention has wide applicability to industries utilizing vessels, such as freighters.

1. A ballast water treatment pack comprising:
a chlorine-based sterilizing agent; and
a wrapper formed of a water-soluble film or a water-soluble fiber entangled body for wrapping the chlorine-based sterilizing agent.

2. The ballast water treatment pack according to claim 1, wherein
the chlorine-based sterilizing agent contains sodium dichloroisocyanurate.

3. The ballast water treatment pack according to claim 1, wherein
the wrapper is formed of the water-soluble film which is a polyvinyl alcohol film.

4. The ballast water treatment pack according to claim 1, wherein
the wrapper is formed of the water-soluble film having a thickness of 10 μm or more and 100 μm or less.

5. The ballast water treatment pack according to claim 1, wherein
the wrapper is formed of the water-soluble fiber entangled body consisting fibers made of polyvinyl alcohol as a raw material.

6. The ballast water treatment pack according to claim 1, wherein
the wrapper is formed of the water-soluble fiber entangled body having a thickness of 10 μm or more and 1000 μm or less.

7. The ballast water treatment pack according to claim 1, wherein
the chlorine-based sterilizing agent has a granular shape with an average granular diameter of 0.1 mm or more and 5 mm or less.

8. A ballast water treatment system provided with a treatment pack putting device, the system comprising:
a water amount measurement part which measures an amount of ballast water contained in a ballast tank; and
a treatment pack putting device control part which determines, based on the amount of the ballast water measured by the water amount measurement part, the number of ballast water treatment packs according to claim 1 to be put in so that a chlorine concentration in the ballast water in the ballast tank reaches a predetermined chlorine concentration reference value, and controls the treatment pack putting device to put the determined number of the ballast water treatment packs in the ballast tank.

9. The ballast water treatment system according to claim 8, further comprising:
a concentration measurement part which measures the chlorine concentration in the ballast water in the ballast tank, wherein
the treatment pack putting device control part determines, further based on the chlorine concentration measured by the concentration measurement part, the number of the ballast water treatment packs to be put in.

10. A ballast water treatment method comprising:
a step of measuring an amount of ballast water in a ballast tank;
a step of determining, based on the measured amount of the ballast water, the number of ballast water treatment packs according to claim 1 so that a chlorine concentration in the ballast water in the ballast tank reaches a predetermined chlorine concentration reference value; and
a step of putting the determined number of the ballast water treatment packs in the ballast tank.

11. The ballast water treatment method according to claim 10, further comprising:
a step of measuring the chlorine concentration in the ballast water in the ballast tank, wherein,
in the step of determining, the number of the ballast water treatment packs to be put in is determined, further based on the measured chlorine concentration.
